(19) United States
(12) Patent Application Publication
(10) Pub. No.: US 2014/0280262 A1
(43) Pub. Date: Sep. 18, 2014

(54) ELECTRONIC DEVICE WITH A FUNICTION OF APPLYING APPLICATIONS OF DIFFERENT OPERATING SYSTEMS AND METHOD THEREOF

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/207,410

(22) Filed: Mar. 12, 2014

(30) Foreign Application Priority Data
Mar. 15, 2013 (CN) 2013100833557

(51) Int. Cl. G06F 3/0481; G06F 17/30; G06F 3/0484

(52) U.S. Cl. CPC G06F 3/04817; G06F 3/04842; G06F 17/30424; G06F 17/30076
USPC 707/756; 707/758; 715/835

(57) ABSTRACT

A method for applying a number of applications of different operating systems on an electronic device, the method includes: providing an icon interface module and displaying the icon interface on the display unit. Storing installation information into a shared storage area of the storage unit after an application is installed on the electronic device in one operating system. The installation information comprises an installation identifier for identifying the installation information and an icon file corresponding to the installed application. Searching whether the shared storage area of the storage unit includes the installation information, in response to an operation of returning to the icon interface. In addition, adding a corresponding icon to the icon interface according to the icon file of the installation information if yes.

### CROSS REFERENCE TO RELATED APPLICATIONS

This application is related to the following co-pending, commonly assigned patent applications, the disclosures of which are incorporated herein by reference in their entirety:

1. “SYSTEM FOR APPLYING APPLICATIONS OF DIFFERENT OPERATING SYSTEMS IN ONE ELECTRONIC DEVICE AND METHOD THEREOF” by Steve Lap Wai Hui, whose Attorney Docket No is US51414.

2. “ELECTRONIC DEVICE WITH A FUNCTION OF APPLYING APPLICATIONS OF DIFFERENT OPERATING SYSTEMS AND METHOD THEREOF” by Steve Lap Wai Hui, whose Attorney Docket No is US51416.

3. “ELECTRONIC DEVICE WITH A FUNCTION OF APPLYING APPLICATIONS OF DIFFERENT OPERATING SYSTEMS, SYSTEM AND METHOD THEREOF” by Steve Lap Wai Hui, whose Attorney Docket No is US51417.

4. “SYSTEM FOR UPDATING ICON INTERFACE WITH ICONS OF DIFFERENT OPERATING SYSTEMS AND METHOD THEREOF” by Steve Lap Wai Hui, whose Attorney Docket No is US51418.

### BACKGROUND

1. Technical Field

The present disclosure relates to electronic devices, and particularly to an electronic device with a function of applying a number of applications of different operating systems, and a system and a method thereof

2. Description of Related Art

Electronic devices, such as mobile phones and tablet computers, are more and more popular. Nowadays, some electronic devices can install two or more different operating systems, such as, a WINDOWS operating system, a LINUX operating system, and an ANDROID operating system, and the electronic device can enter a certain operating system selected by a user or by default. However, when the electronic device enters one certain operating system, only the applications of the entered operating system are displayed and can be applied. If the user wants to apply an application of another operating system and the user is not sure which operating system the application belongs to, the user should switch the electronic device to another operating system one by one and search for the application, which is inconveniently.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device with a function of applying a number of applications of different operating systems.

FIG. 2 is a schematic diagram of an embodiment of an icon interface.

FIG. 3 is a schematic diagram of another embodiment of an icon interface.

FIG. 4 is a flowchart diagram of an embodiment of a method for applying a number of applications of different operating systems.

FIG. 5 is a flowchart diagram of an embodiment of a step of updating icons of an icon interface, of the method of FIG. 4.

FIG. 6 is a flowchart diagram of an embodiment of a controlling step in response to an operation of an icon, of the method of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

FIG. 1 shows an embodiment of an electronic device 100 with a function of applying a number of applications of different operating systems. A number of operating systems have been installed in the electronic device 100, such as, a LINUX operating system, a WINDOWS operating system, an ANDROID operating system, and a MAC operating system. The electronic device 100 can be a mobile phone, a tablet computer, a portable computer, or a desktop computer, for example.

FIG. 1 shows that the electronic device 100 includes a display unit 10, a processing unit 20, and a storage unit 30. In the embodiment, the display unit 10 is a touch screen; in another embodiment, the display unit 201 can be a display screen and the display unit 10 combines a keyboard or a touchpad to constitute an input/output device. The processing unit 20 can be a central processing unit, a digital processor, or a single chip, for example. The storage unit 30 can be a hard disk, a flash memory, or a compact disk, for example.

The processing unit 20 is used to run a system S1 controlling the applying a number of applications of different operating systems. The system S1 includes an interface providing module 21, a store controlling module 22, and an icon updating module 23. In the embodiment, the interface providing module 21, the store controlling module 22, and the icon updating module 23 are collection of software instructions and executed by the processing unit 20 of the electronic device 100.

FIG. 2 shows that the interface providing module 21 is used to provide an icon interface TS and display the icon interface TS on the display unit 10. The icon interface TS includes a number of icons TI, the icons TI correspond to a number of applications running in different operating systems (hereinafter, the icons TI of different operating systems). For example, the icons TI include a browser icon TI1 of the LINUX operating system, a media player 1 icon TI2 of the ANDROID system. In the embodiment, the icon interface TS provided by the interface providing module 21 is independent from the operating systems installed in the electronic device 100. FIG. 2 shows in the embodiment, the icons TI corresponding to different operating systems are arranged in the icon interface TS randomly.

FIG. 3 shows in another embodiment, each operating system is assigned with a corresponding area on the display unit 10 for locating the icons TI. For example, the icons TI from the same operating system are located in the same row. Therefore, a user can operate and manage the icons TI of the same operating system conveniently.

In the embodiment, as shown in FIG. 1, the storage unit 30 includes a shared storage area 31. The store controlling module 22 is used to store installation information into the shared storage area 31 of the storage unit 30 after an application is installed on the electronic device 100 in one operating system by a user. The shared storage area 31 of the storage unit 30 can be read and can be written by the electronic device 100 in each operating system. The installation information includes an installation identifier and an icon file corresponding to the installed application. The icon file includes an icon name, an icon image, identification information of the installed application, and an operating system running the installed application. The installation identifier is used to identify the installation information.

In the embodiment, as shown in FIG. 2, the icon interface TS provided by the interface providing module 21 also includes a number of operating system icons, such as an ANDROID operating system icon, and a WINDOWS operating system icon. The electronic device 100 can enter the corresponding operating system when the user operates the corresponding operating system icon. For example, if the user operates/selects the ANDROID operating system icon, then the electronic device 100 would be triggered enter the ANDROID operating system. It is well known in the art that when the electronic device 100 enters a certain operating system, the user can install the application supported by the corresponding operating system.

The icon updating module 23 is used to search whether the shared storage area 31 of the storage unit 30 includes the installation information, in response to an operation of returning to the icon interface TS. When the icon updating module 23 searches the installation information from the shared storage area 31, the icon updating module 23 adds a corresponding icon TI to the icon interface TS according to the icon file of the installation information. Therein, the operation of returning to the icon interface TS can be an operation of shutting down current operating system interface or an operation for a particular return key (not shown).

In detail, the icon updating module 23 adds a corresponding icon TI to the icon interface TS according to the icon file of the installation information as follows. The icon updating module 23 converts a format of the icon file of the installation information into a format supported by the icon interface TS, and then adds the icon TI to the icon interface TS according to the converted icon file. In the embodiment, the icon interface TS is run in an interface system different from the operating systems installed in the electronic device 100. For example, the interface system can be a small operating system personally developed and different from the known operating system, such as the WINDOWS operating system and the ANDROID operating system.

In the embodiment, the store controlling module 22 also stores uninstall information into the shared storage area 31 of the storage unit 30 after an application of the electronic device 100 in one operating system is uninstalled by the user. The uninstall information includes an uninstall identifier and an icon file corresponding to the uninstalled application. Correspondingly, the uninstall identifier is used to identify the uninstall information. The icon file includes an icon name, an icon image, identification information of the uninstalled application, and an operating system running the uninstalled application.

The icon updating module 23 also searches whether the shared storage area 31 of the storage unit 30 includes the uninstall information, in response to an operation of returning to the icon interface TS. When the icon updating module 23 searches the uninstall information from the shared storage area 31, the icon updating module 23 deletes a corresponding icon TI from the icon interface TS according to the icon file of the uninstall information. In detail, the icon updating module 23 converts the format of the icon file to the format supported by the icon interface TS, and determines the icon TI corresponding to the icon file from the icon interface TS, and then deletes the determined icon TI from the icon interface TS.

In the embodiment, the icon updating module 23 deletes the installation information corresponding to one icon TI after adding the icon TI on the icon interface TS and deletes the uninstall information corresponding to one icon TI after deleting the icon TI from the icon interface TS. In another embodiment, the icon updating module 23 adds a particular identifier into the installation information corresponding to one icon TI after adding the icon TI on the icon interface TS, and adds a particular identifier into the uninstall information corresponding to one icon TI after deleting the icon TI from the icon interface TS.

Therefore, when an application has been installed in the electronic device 100 in any operating system, the icon TI corresponding to the application is added on the icon interface TS by the controlling system S1. When the electronic device 100 has uninstalled an application in any operating system, the icon TI corresponding to the application is removed/deleted from the icon interface TS by the controlling system S1.

In the embodiment, the controlling system S1 also includes an operation detection module 24, an application determination module 25, and an execution controlling module 26 which are collection of software instructions.

The operation detection module 24 detects operations on the icon interface TI by the user and determines an icon TI selected by the user according to the operation of the user.

The application determination module 25 is used to determine an application corresponding to the selected icon TI and an operating system supporting the application.

The execution controlling module 26 is used to start the operating system supporting the application, and control to execute the application in the operating system. For example, if the application determination module 25 determines the application corresponding to the selected icon TI is media player 1 (Android) supported by the ANDROID operating system, then the execution controlling module 26 controls the ANDROID operating system to start and controls the application of the media player 1 to execute in the ANDROID operating system.

In the embodiment, the storage unit 30 stores relationship information of each icon TI, the relationship information includes identification information of the application corresponding to the icon TI and identification information of the corresponding operating system. The application determination module 25 obtains the identification information according to the icon TI selected by the user, and determines the application corresponding to the selected icon TI according to the identification information of the application, and determines the operating system supporting the application according to the identification information of the operating system. In the embodiment, the execution controlling module 26 starts the operating system which can be switched to the operating system of the electronic device 100 from another operating system.

FIG. 4 shows a flowchart of a method for applying a number of applications of different operating systems. The method is applied in the electronic device 100 of FIG. 1.

The method includes steps of: 1) executing a step of updating the icons TI of the icon interface TS (S31); and 2) executing a controlling step in response to operating an icon TI of the icon interface TS (S32).

FIG. 5 is a detail flowchart diagram of the step (S31) of updating icons of an icon interface of the method of FIG. 4.

First, the interface providing module 21 provides an icon interface TS and displays the icon interface TS on the display unit 10 (S401).

The store controlling module 22 stores installation information into the shared storage area 31 of the storage unit 30 after an application is installed on the electronic device 100 in one operating system (S402). Therein, the installation information includes an installation identifier and an icon file corresponding to the installed application. The icon file includes an icon name, an icon image, identification information of the installed application, and an operating system supporting the installed application. The installation identifier is used to identify the installation information.

The icon updating module 23 searches whether the shared storage area 31 of the storage unit 30 includes the installation information, in response to an operation of returning to the icon interface TS (S403).

If yes, the icon updating module 23 adds a corresponding icon TI to the icon interface TS according to the icon file of the installation information (S405). In detail, the icon updating module 23 converts a format of the icon file of the installation information into a format supported by the icon interface TS, and then adds the icon TI to the icon interface TS according to the converted icon file.

In the embodiment, the step S31 also includes steps as follows: the store controlling module 22 stores uninstall information into the shared storage area 31 of the storage unit 30 after an application of the electronic device 100 in one operating system is uninstalled (S407).

The icon updating module 23 searches that whether the shared storage area 31 of the storage unit 30 includes the uninstall information, in response to an operation of returning to the icon interface TS (S409). The uninstall information includes an uninstall identifier and an icon file corresponding to the uninstalled application. The uninstall identifier is used to identify the uninstall information.

If yes, the icon updating module 23 deletes a corresponding icon TI from the icon interface TS according to the icon file of the uninstall information (S411). In detail, the icon updating module 23 converts the format of the icon file to the format supported by the icon interface TS, and determines the icon TI corresponding to the icon file from the icon interface TS, and then deletes the determined icon TI from the icon interface TS.

FIG. 6 is a flowchart diagram of an embodiment of a controlling step (S32) in response to an operation of an icon, of the method of FIG. 4.

The operation detection module 24 detects operations on the icon interface TI by the user and determines an icon TI selected by the user according to the operation of the user (S501).

The application determination module 25 determines an application corresponding to the selected icon TI and an operating system supporting the application (S503).

The execution controlling module 26 starts the operating system supporting the application, and controls the application to execute in the operating system (S505).

Therefore, utilizing the system S1 and method, the present disclosure enables the user to apply the applications of different operating systems on the electronic device 100 conveniently.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with a function of applying a plurality of applications of different operating systems, the electronic device installed a plurality of operating systems, the electronic device comprising:
a display unit;
a storage unit comprising a shared storage area; and
a processing unit comprising:
an interface providing module configured to provide an icon interface and display the icon interface on the display unit;
a store controlling module configured to store installation information into the shared storage area of the storage unit after an application is installed on the electronic device in one operating system, wherein the installation information comprises an installation identifier for identifying the installation information and an icon file corresponding to the installed application; and
an icon updating module configured to search whether the shared storage area of the storage unit comprises the installation information, in response to an operation of returning to the icon interface, and add a corresponding icon to the icon interface according to the icon file of the installation information when searching the installation information of the storage unit.

2. The electronic device according to claim 1, wherein the icon updating module converts a format of the icon file of the installation information into a format supported by the icon interface, and then adds the icon to the icon interface according to the converted icon file.

3. The electronic device according to claim 1, wherein the store controlling module is further configured to store uninstall information into the shared storage area of the storage unit after an application of the electronic device in one operating system is uninstalled, the uninstall information comprises an uninstall identifier for identifying the uninstall information and an icon file corresponding to the uninstalled application.

4. The electronic device according to claim 3, wherein the icon updating module is further configured to search whether the shared storage area of the storage unit comprises the uninstall information, in response to an operation of returning to the icon interface, and delete a corresponding icon from the icon interface according to the icon file of the uninstall information when searching the uninstall information of the storage unit.

5. The electronic device according to claim 4, wherein the icon updating module converts the format of the icon file to the format supported by the icon interface, and determines the icon corresponding to the icon file from the icon interface, and then deletes the determined icon from the icon interface.

6. An electronic device with a function of applying a plurality of applications of different operating systems, the electronic device has installed a plurality of operating system, the electronic device comprising:
a display unit configured to display an icon interface, the icon interface comprises a plurality of icons corresponding to a plurality of applications running in different operating systems; and
a processing unit comprising:
an operation detection module configured to detect operations on the icon interface by the user and determines an icon selected by the user according to the operation of the user;
an application determination module configured to determine an application corresponding to the selected icon and an operating system supporting the application; and
an execution controlling module configured to start the operating system supporting the application, and control to execute the application in the operating system.

7. The electronic device according to claim 6, further comprising a storage unit storing relationship information of each icon of the icon interface, the relationship information comprises identification information of the application corresponding to the icon and identification information of the corresponding operating system; the application determination module obtains the identification information according to the icon selected by the user, and determines the application corresponding to the selected icon according to the identification information of the application, and determines the operating system supporting the application according to the identification information of the operating system.

8. A method for applying a plurality of applications of different operating systems on an electronic device, the electronic device comprises a display unit and a storage unit, the method comprising:
providing an icon interface and displaying the icon interface on the display unit, wherein the icon interface comprises a plurality of icons corresponding to a plurality of applications running in different operating systems;
storing installation information into a shared storage area of the storage unit after an application is installed on the electronic device in one operating system, wherein the installation information comprises an installation identifier for identifying the installation information and an icon file corresponding to the installed application;
searching that whether the shared storage area of the storage unit comprises the installation information, in response to an operation of returning to the icon interface; and
adding a corresponding icon to the icon interface according to the icon file of the installation information when searching the installation information of the storage unit.

9. The method according to claim 8, further comprising:
storing uninstall information into the shared storage area of the storage unit after an application of the electronic device in one operating system is uninstalled, wherein the uninstall information comprises an uninstall identifier for identifying the uninstall information and an icon file corresponding to the uninstalled application;
searching that whether the shared storage area of the storage unit comprises the uninstall information, in response to an operation of returning to the icon interface; and
deleting a corresponding icon from the icon interface according to the icon file of the uninstall information when searching the uninstall information of the storage unit.

10. The method according to claim 8, wherein the step of adding a corresponding icon to the icon interface according to the icon file of the installation information comprises:
converting a format of the icon file of the installation information into a format supported by the icon interface; and
adding the icon to the icon interface according to the converted icon file.

11. The method according to claim 9, wherein the step of deleting a corresponding icon from the icon interface according to the icon file of the uninstall information comprises:
converting the format of the icon file to the format supported by the icon interface, and determining the icon corresponding to the icon file from the icon interface, and then deleting the determined icon from the icon interface.

12. A method for applying a plurality of applications of different operating systems on an electronic device, the electronic device comprises a display unit and a storage unit, the method comprising:
detecting operations on an icon interface displayed on a display unit of the electronic device by the user and determining an icon selected by the user according to the operation of the user, wherein the icon interface comprises a plurality of icons corresponding to a plurality of applications running in different operating systems;
determining an application corresponding to the selected icon and an operating system supporting the application; and
starting the operating system supporting the application, and controlling to execute the application in the operating system.

13. The method according to claim 12, wherein the step of determining an application corresponding to the selected icon and an operating system supporting the application comprises:
obtaining identification information according to the icon selected by the user, wherein the relationship information comprises identification information of the application corresponding to the icon and identification information of the corresponding operating system;
determining the application corresponding to the selected icon according to the identification information of the application, and determining the operating system supporting the application according to the identification information of the operating system.
